(19) United States
(12) Patent Application Publication
(10) Pub. No.: US 2022/0183329 A1
(43) Pub. Date: Jun. 16, 2022

(54) VACUUM MICROWAVE DRYING OF HIGH SUGAR CONTENT LIQUIDS

(71) Applicant: EnWave Corporation, Delta (CA)

(72) Inventors: Guopeng Zhang, Surrey (CA); Braden Knights, Abbotsford (CA); Shafique Ahmad, Delta (CA)

(21) Appl. No.: 17/595,521

(22) PCT Filed: Jun. 14, 2019
(86) PCT No.: PCT/CA2019/050850

§ 371 Date: Nov. 18, 2021

(51) Int. Cl. A23L 3/015; F26B 5/04

(52) U.S. Cl. CPC A23L 3/0155; F26B 5/048

(57) ABSTRACT

A method of drying high sugar content food products such as honey and molasses in a vacuum microwave chamber. The method comprises loading the food product into the vacuum chamber, and exposing the food product to a vacuum pressure in the range of 45 to 250 Torr (60 to 333 mbar) in the vacuum chamber while irradiating the food product with microwave radiation. This dries the food product and forms a porous structure. The method minimizes or prevents foaming and dries the product at a temperature that prevents burning, while reducing the moisture content to a very low level.

### FIELD

The invention pertains to methods of drying food products having a high sugar content, such as honey and molasses.

### BACKGROUND

Dehydration of organic materials is commonly done in the food processing industry to preserve the products for storage or to create products that are used in the dehydrated form, for example dried herbs and various kinds of chips. It is known to dehydrate food products by vacuum microwave dehydration. Examples of this in the patent literature include WO 2009/049409 dated Apr. 23, 2009, WO 2009/033285 dated Mar. 19, 2009, WO 2011/085467 dated Jul. 21, 2011, WO 2013/010257 dated Jan. 24, 2013, and WO 2014/085897 dated Jun. 12, 2014. Vacuum microwave drying is a rapid method that can yield products with improved quality compared to air-dried and freeze-dried products. Because the drying is done under reduced pressure, the boiling point of water and the oxygen content of the atmosphere are lowered, so nutritional components sensitive to oxidation and thermal degradation can be retained to a high degree.

Although a wide range of food products can be dried by vacuum microwave processing, successful drying of liquid food products having a high sugar content has not been achieved in the prior art. This type of product, having a sugar content greater than 20 weight percent, is typically in the form of a viscous liquid. Such products experience foaming and splashing at the vacuum pressures conventionally used during vacuum microwave drying. Further, the structure of the product collapses in the vacuum chamber, trapping moisture that cannot be removed without burning of the product. There is a need in the food processing art for an effective method of drying high sugar content products.

### SUMMARY OF THE INVENTION

The present inventors have discovered that high sugar content food products can be dried using vacuum microwave drying to produce a commercially-acceptable product by using processing conditions that include a vacuum pressure in the range of 45 to 250 Torr (60 to 333 mbar). This has been found, surprisingly, to minimize or prevent foaming of the product and dry the product at a temperature that prevents burning, while reducing the moisture content to a very low level.

According to one embodiment of the invention, there is provided a method of dehydrating a food product having a sugar content of at least 20 wt. %, comprising the steps of: (a) loading the food product into a vacuum chamber; (b) exposing the food product to a vacuum pressure in the range of 45 to 250 Torr (60 to 333 mbar) in the vacuum chamber; (c) exposing the food product to microwave radiation during step (b), whereby the food product is dehydrated; and (d) unloading the dehydrated food product from the vacuum chamber.

These and other aspects and features of the invention will be apparent from the following description of the specific embodiments.

### BRIEF DESCRIPTION OF THE DRAWING

FIG. 1 is a schematic diagram of a vacuum microwave dehydration apparatus suitable for carrying out the process of the invention.

### DETAILED DESCRIPTION OF PREFERRED EMBODIMENTS

The method of the invention dehydrates high sugar content food products using a vacuum microwave apparatus. In general terms, this is done by exposing the food product to a selected vacuum pressure and to microwave radiation in a vacuum chamber for a selected residence time, thereby heating the product and reducing moisture to a desired level. In one embodiment, the process is done on a continuous-throughput basis, in which the product is fed into a vacuum chamber and conveyed through the vacuum chamber from an input end to an output end, for a selected residence time, during which microwave generators irradiate the product with microwave radiation. In another embodiment, the process is done on a batch basis, by loading the vacuum chamber, processing the product and then opening the vacuum chamber to remove the dried product. If desired, the dried product may be milled to form a powder.

The food products suitable for processing by the invention have a high sugar content, in the range of 20 to 85 wt. %, alternatively in the range of 40 to 80 wt. %.

For example, honey and molasses have a sugar content of about 80 wt. %, corn syrup about 75 wt. % and sweetened condensed milk about 50 wt. %. This is much higher than the sugar content of most other food products that would be processed using vacuum microwave drying, which are commonly less than 10 wt. % sugar. The high sugar content food products for processing by the present invention are typically in the form of a viscous liquid. The process uses vacuum pressures in the range of about 45 to 250 Torr (60 to 333 mbar), alternatively 50 to 250 Torr (66.7 to 333 mbar), alternatively 50 to 200 Torr (66.7 to 267 mbar), alternatively 50 to 100 Torr (66.7 to 133 mbar), in the vacuum chamber. The present inventors have determined that processing high sugar content products at less than about 45 Torr, or less than 50 Torr, results in uncontrollable foaming during vacuum microwave drying at any microwave power density suitable to dry the product; and that processing at vacuum pressures above 250 Torr does not dry the viscous liquid to a porous structure, which is preferred. Pressures in the range of 45 to 250 Torr have been found suitable to control foaming and splashing of high sugar content products, prevent collapse of the product structure, and permit the product to be dried to a low moisture content and form a uniform finished product. The food product dries in the vacuum chamber at a temperature that is high enough to ensure proper drying while not being high enough to burn the product. For example, suitable temperatures of the product during drying are in the range of 75 to 125° C., alternatively in the range of 90 to 110° C.

Suitable microwave power densities are in the range of 100 to 3000 kW per kg of food product. Lower power densities will eventually dry the product but require too long a drying time to be commercially practical. Higher power densities have been determined to cause excessive foaming or splashing of high sugar content liquids during drying.

In some embodiments, maltodextrin is added to the food product prior to drying. For example, 5 to 30 wt. % may be added. This has been determined to assist in the drying process and produce a more porous, evenly-dried product, having a more even pore distribution.

Residence times in the vacuum chamber in the range of 30 to 90 minutes, alternatively 40 to 70 minutes, have been found suitable for drying most high sugar content materials. Following the dehydration step, the dried product is unloaded from the vacuum chamber. The final moisture level of the dried material may be in the range of 0 to 10 wt. %, alternatively in the range of 1 to 4 wt. %.

In one embodiment, the dehydration process is done using a continuous throughput vacuum microwave drying apparatus in which the pressure is less than atmospheric and microwave generators are arranged to irradiate the product, at a constant or variable energy output. The food product to be dried is loaded into the vacuum chamber at its input end and is moved through the vacuum chamber to its output end. The dehydrated product is then unloaded from the output end of the vacuum chamber.

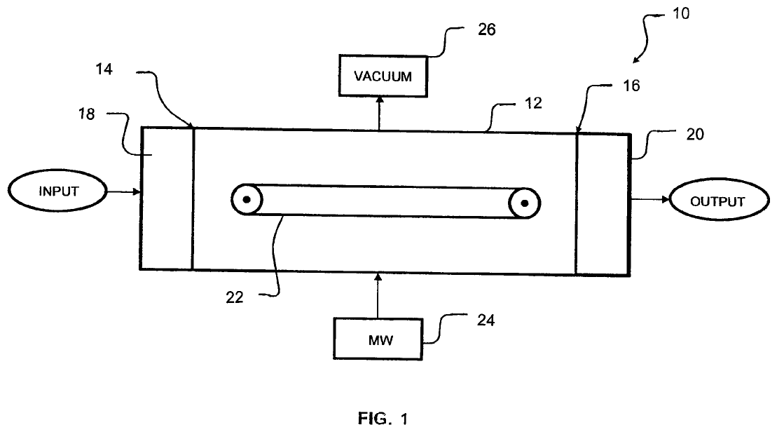

FIG. 1 schematically illustrates an apparatus for carrying out the process on a continuous throughput basis. The vacuum microwave dehydrator 10 comprises a vacuum chamber 12 having an input end 14 for introduction of the material and an output end 16 for removal of the dried product. A first airlock 18 is arranged at the input end and a second airlock 20 at the output end, for loading and unloading the product. A conveyor 22 is provided to transport the material on trays, typically at constant speed, from the input end to the output end of the vacuum chamber. A microwave source 24 is arranged to irradiate microwave energy into the vacuum chamber. A vacuum source 26 is operatively connected to the vacuum chamber for reducing the pressure inside it to a pressure below atmospheric

The drying apparatus 10 includes components that are conventionally required for vacuum microwave dehydrators, including a condenser, a refrigeration unit, a vacuum pump, a water load system, and a programmable logic controller (PLC) for controlling the operation of the system, including controlling the conveyor drive motors, the microwave generators, the vacuum pump, the refrigerant pumps and the airlocks.

An example of a vacuum microwave dehydrator suitable for carrying out the process of the invention is a travelling wave-type apparatus, as disclosed in WO 2011/085467, commercially available from EnWave Corporation of Delta, BC, Canada under the trademark quantaREV. Using such apparatus, the high sugar content food product is fed into the vacuum chamber on trays and is conveyed across a microwave-transparent window on a conveyor belt while being subjected to vacuum pressure and microwave radiation.

Food products suitable for dehydration by the method of the invention include honey, molasses, maple syrup, agave syrup, caramel, corn syrup, date syrup and sweetened condensed milk, and other sugary viscous liquids.

### EXAMPLES

### Example 1

As a control, a 133 gram sample of date syrup, having an initial moisture content of about 25 wt. % was processed in a vacuum microwave apparatus at a vacuum pressure of 25 Torr and a microwave power level of 1200 W. The product started foaming within 30 seconds and overflowed its dish. It could not be dried to a finished product.

### Example 2

A sample of honey weighing 69 g and having an initial moisture content of 20 wt. % was processed in a batch-type vacuum microwave drier. The vacuum pressure was 60±2 Torr. The microwave output power was a constant 1200 W. The residence time was 52 minutes. No product foaming or burning was observed. The final temperature of the product was 100° C. The final product weight was 56.5 g and the final moisture content was 2.3 wt. %. The product dried to an even, porous structure that could be easily milled into a powder.

### Example 3

A sample of honey (Manuka) weighing 7,855 g and having an initial moisture content of about 15-20 wt. % was poured onto parchment-lined trays and processed in a continuous-throughput vacuum microwave drier (a quantaREV machine, made by EnWave Corporation). The vacuum pressure was 90±5 Torr. The microwave output power was a constant 4 kW. The residence time was 40 minutes. No product foaming or burning was observed. The final temperature of the product was 104° C. The final product weight was 6,582 g and the final moisture content was 2.5 wt. %. The product dried to an even, porous structure.

### Example 4

A sample of white corn syrup weighing 136.5 g and having an initial moisture content of about 22 to 25 wt. % was poured into a parchment-lined tray and processed in a batch-type vacuum microwave drier. The vacuum pressure was 80±2 Torr. The microwave output power was a constant 1200 W. The residence time was 60 minutes. No product foaming or burning was observed. The final temperature of the product was 77° C. The final product weight was 106.9 g and the final moisture content was 2.6 wt. %. The product dried to an even, porous structure.

### Example 5

A sample of white corn syrup was mixed with 20 wt. % maltodextrin. The mixed sample weighed 95.2 g and had an initial moisture content of about 20 wt. %. It was poured into a parchment-lined tray and processed in a batch-type vacuum microwave drier. The vacuum pressure was 80±2 Torr. The microwave output power was a constant 1600 W. The residence time was 50 minutes. No product foaming or burning was observed. The final temperature of the product was 77° C. The final product weight was 76.4 g and the final moisture content was 1.5 wt. %. The product dried to a cake similar in structure to Styrofoam. It was observed that maltodextrin appeared to assist in forming the structure, causing a more even pore distribution.

### Example 6

A sample of date syrup weighing 133 g and having an initial moisture content of about 25 wt. % was processed in a batch-type vacuum microwave drier. The vacuum pressure was 50±2 Torr. The microwave output power was 800 W for 20 minutes, followed by 1600 W for 25 minutes, followed by 2400 W for 10 minutes. No product burning was observed. The final temperature of the product was 105° C. The final product weight was 101.1 g and the final moisture content was 1.6 wt. %. The product dried to an even, porous structure.

### Example 7

A sample of molasses weighing 127.9 g and having an initial moisture content of about 20 wt. % was poured into a parchment-lined tray and processed in a batch-type vacuum microwave drier. The vacuum pressure was 80±2 Torr. The microwave output power was 1200 W for 60 minutes, followed by 2000 W for 700 seconds. No foaming or product burning was observed. The final temperature of the product was 110° C. The final product weight was 103.9 g and the final moisture content was 1.5 wt. %. The product dried to an even, porous structure.

### Example 8

A sample of molasses was mixed with 20 wt. % maltodextrin. The mixed sample weighed 92.5 g and had an initial moisture content of about 18 wt. %. It was poured into a parchment-lined tray and processed in a batch-type vacuum microwave drier. The vacuum pressure was 80±2 Torr. The microwave output power was a constant 1600 W. The residence time was 50 minutes. No product foaming or burning was observed. The final temperature of the product was 100° C. The final product weight was 76.5 g and the final moisture content was 0.8 wt. %. It was observed that maltodextrin appeared to assist in forming the final product structure.

### Example 9

A sample of Eagle Brand™ sweetened condensed milk weighing 56.9 g and having an initial moisture content of about 25 wt. % was processed in a batch-type vacuum microwave drier. The vacuum pressure was 60±2 Torr. The microwave output power was 1200 W for 10 minutes, followed by 2000 W for 30 minutes. No foaming or product burning was observed. The final temperature of the product was 90° C. The final product weight was 43.2 g and the final moisture content was 1.2 wt. %. The product dried to an even, porous structure.

As will be apparent to those skilled in the art in the light of the foregoing disclosure, many alterations and modifications are possible in the practice of this invention without departing from the scope thereof. Accordingly, the scope of the invention is to be construed in accordance with the following claims.

What is claimed is:

1. A method of dehydrating a food product having a sugar content of at least 20 wt. %, comprising the steps of:
(a) loading the food product into a vacuum chamber;
(b) exposing the food product to a vacuum pressure in the range of 45 to 250 Torr (60 to 333 mbar) in the vacuum chamber;
(c) exposing the food product to microwave radiation during step (b), whereby the food product is dehydrated; and
(d) unloading the dehydrated food product from the vacuum chamber

2. A method according to claim 1, wherein the food product has a sugar content in the range of 20 to 85 wt. %.

3. A method according to claim 1, where the food product has a sugar content of at least 40 wt. %.

4. A method according to claim 1, wherein the food product has a sugar content in the range of 40 to 80 wt. %.

5. A method according to claim 1, wherein the pressure in step (b) is in the range of 50 to 250 Torr.

6. A method according to claim 1, wherein the pressure in step (b) is in the range of 50 to 200 Torr.

7. A method according to claim 1, wherein the pressure in step (b) is in the range of 50 to 100 Torr.

8. A method according to claim 1, wherein the dehydrated food product has a moisture content in the range of 0 to 10 wt. %.

9. A method according to claim 1, wherein the dehydrated food product has a moisture content in the range of 1 to 4 wt. %.

10. A method according to claim 1, wherein the product temperature during step (c) is in the range of 75 to 125° C.

11. A method according to claim 1, wherein the product temperature during step (c) is in the range of 90 to 110° C.

12. A method according to claim 1, wherein the residence time of the food product in the vacuum chamber is in the range of 30 to 90 minutes.

13. A method according to claim 1, wherein the residence time of the food product in the vacuum chamber is in the range of 40 to 70 minutes.

14. A method according to claim 1, wherein a power density of the microwave radiation is in the range of 100 to 3000 kW/kg of the food product.

15. A method according to claim 1, further comprising the step of adding maltodextrin to the food product before step (a).

16. A method according to claim 15, wherein the maltodextrin is in the range of 5 to 30 wt. % of the food product.

17. A method according to claim 1, wherein the method is done on a continuous throughput basis.

18. A method according to claim 1, further comprising the step of milling the dehydrated food product to form a powder.

19. A method according to claim 1, wherein the food product comprises a viscous liquid.

20. A method according to claim 1, wherein the dehydrated food product is porous.

21. A method according to claim 1, wherein the food product is selected from the group consisting of honey, molasses, maple syrup, agave syrup, caramel, corn syrup, date syrup and sweetened condensed milk.
